(19) United States
(12) Patent Application Publication
(10) Pub. No.: US 2010/0139774 A1
(43) Pub. Date: Jun. 10, 2010

(54) Fluid elements

(76) Inventor: Svetozar B. Petrovich, Chicago, IL (US)

Correspondence Address: Mr. Svetozar B. Petrovich, 6526 North Ponchartrain Blvd., Chicago, IL, 60646, US

(21) Appl. No.: 12/658,099

(22) Filed: Feb. 1, 2010

Related U.S. Application Data
(63) Continuation of application No. 12/320,440, filed on Jan. 26, 2009.
Application No. 12/320,440 is a continuation of application No. 12/382,448, filed on Mar. 17, 2009.
Application No. 12/382,448 is a continuation of application No. 11/724,752, filed on Mar. 15, 2007.
Application No. 11/724,752 is a continuation of application No. 12/453,444, filed on May 12, 2009.
Application No. 12/453,444 is a continuation of application No. 12/320,441, filed on Jan. 26, 2009.
Application No. 12/320,441 is a continuation of application No. 12/153,036, filed on May 13, 2008.
Application No. 12/153,036 is a continuation of application No. 11/809,132, filed on May 31, 2007, now abandoned.
Application No. 11/809,132 is a continuation of application No. 11/807,748, filed on May 30, 2007, now abandoned.
Application No. 11/807,748 is a continuation of application No. 11/788,172, filed on Jun. 4, 2007, now abandoned.
Application No. 11/788,172 is a continuation of application No. 11/504,304, filed on Aug. 14, 2006, now abandoned.
Application No. 11/504,304 is a continuation of application No. 11/418,157, filed on May 3, 2006, now abandoned.
Application No. 11/418,157 is a continuation of application No. 11/385,078, filed on Mar. 20, 2006, now abandoned.
Application No. 11/385,078 is a continuation of application No. 11/342,006, filed on Jan. 30, 2006, now abandoned.
Application No. 11/342,006 is a continuation of application No. 11/233,546, filed on Sep. 23, 2005, now abandoned.
Application No. 11/233,546 is a continuation of application No. 11/212,943, filed on Aug. 25, 2005, now abandoned.
Application No. 11/212,943 is a continuation of application No. 11/188,339, filed on Jul. 25, 2005, now abandoned.
Application No. 11/188,339 is a continuation of application No. 11/028,982, filed on Jan. 3, 2005, now abandoned.
Application No. 11/028,982 is a continuation of application No. 10/869,752, filed on Jun. 16, 2004, now abandoned.
Application No. 10/869,752 is a continuation of application No. 10/840,152, filed on May 5, 2004, now abandoned.
Application No. 10/840,152 is a continuation of application No. 10/742,485, filed on Dec. 19, 2003, now abandoned.
Application No. 10/742,485 is a continuation of application No. 10/190,993, filed on Jul. 8, 2002, now abandoned.
Application No. 10/190,993 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 10/869,752, filed on Jun. 16, 2004, now abandoned.
Application No. 10/869,752 is a continuation of application No. 10/840,152, filed on May 5, 2004, now abandoned.
Application No. 10/840,152 is a continuation of application No. 10/195,668, filed on Jul. 15, 2002, now abandoned.
Application No. 10/195,668 is a continuation of application No. 10/073,914, filed on Feb. 14, 2002, now abandoned.
Application No. 10/073,914 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 08/950,898, filed on Oct. 15, 1997, now Pat. No. 5,941,273.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. G05D 7/00

(52) U.S. Cl. 137/2

(57) ABSTRACT

Fluid composition functions conforming globose quanta least mass, highest elevation least height least length continuous compact composite fluid mass free-surfaces, a rotations composite quanta mass energy perimeter globose and conduit Universe least height surfaces most conserve energy; conforming embodiments quintessential core, natural disposition, genomes, mass energy highest conserving compact composites with completely matched complete complements embody forms; an inflow Inlet, a globose perimeters enclosure and an outlet embodied Sets or drain traps quanta quantum mass PP lengths least sum, in part an upper retention submerged a transition region, and a globose Inlet lower end, an End 2, or a globose-inverse outlet spout lower end, a First End, and respective undersurfaces;

This application is a continuation of the following Application Ser. Nos.:
12/320,440 Jan. 26, 2009 and is a continuation of
12/382,448 Mar. 17, 2009 and is a continuation of
11/724,752 Mar. 15, 2007 and is a DIV CON of
12/453,444 May 12, 2009 and is a DIV CON of
12/320,441 Jan. 26, 2009 and is a DIV CON of
12/153,036 May 13, 2008 and is a continuation of
11/809,132 May 31, 2007 and is a continuation of
11/807,748 May 30, 2007 and is a continuation of
11/788,172 Jun. 4, 2007 and is a continuation of
11/504,304 Aug. 14, 2006 and is a continuation of
11/418,157 May 3, 2006 and is a continuation of
11/385,078 Mar. 20, 2006 and is a continuation of
11/342,006 Jan. 30, 2006 and is a continuation of
11/233,546 Sep. 23, 2005 and is a continuation of
11/212,943 Aug. 25, 2005 and is a continuation of
11/188,339 Jul. 25, 2005 and is a continuation of
11/028,982 Jan. 3, 2005 and is a continuation of
10/869,752 Jun. 16, 2004 and is a continuation of
10/840,152 May 5, 2004 and is a continuation of
10/742,485 Dec. 19, 2003 and is a continuation of
10/190,993 Jul. 8, 2002 and is a continuation of
10/156,192 May 28, 2002 and is a continuation of
10/074,966 Feb. 13, 2002 and is a continuation of
09/850,927 May 8, 2001 and is a continuation of
09/518,884 Mar. 6, 2000 and is a continuation of
09/376,957 Aug. 18, 1999 and said
10/869,752 Jun. 16, 2004 and is a continuation of said
10/840,152 May 5, 2004 and is a continuation of said
10/156,192 May 28, 2002 and is a continuation of said
10/074,966 Feb. 13, 2002 and is a continuation of said
09/850,927 May 8, 2001 and is a continuation of said
09/518,884 Mar. 6, 2000 and is a continuation of said
09/376,957 Aug. 18, 1999 and said
10/869,752 Jun. 16, 2004 and is a continuation of
10/195,668 Jul. 15, 2002 and is a continuation of
10/073,914 Feb. 14, 2002 and is a continuation of said
09/850,927 May 8, 2001 and is a continuation of said
09/518,884 Mar. 6, 2000 and is a continuation of said
09/376,957 Aug. 18, 1999 and said
10/742,485 Dec. 19, 2003 and is a continuation of said
10/156,192 May 28, 2002 and is a continuation of said
10/190,993 Jul. 8, 2002 and is a continuation of said
10/073,914 Feb. 14, 2002 and is a continuation of said
10/074,966 Feb. 13, 2002 and is a continuation of said
09/850,927 May 8, 2001 and is a continuation of said
09/518,884 Mar. 6, 2000 and is a continuation of said
09/376,957 Aug. 18, 1999 and said
09/850,927 May 8, 2001 claims benefit of
60/231,514 Sep. 9, 2000 and claims benefit of
60/226,750 Aug. 21, 2000 and claims benefit of
60/220,358 Jul. 24, 2000 and claims benefit of
60/217,308 Jul. 11, 2000 and is continuation of
09/518,884 Mar. 6, 2000 (contains 09/376,957 Aug. 18, 1999) and claims benefit of
60/123,504 Mar. 9, 1999 and claims benefit of
60/123,207 Mar. 8, 1999 and claims benefit of
60/123,153 Mar. 6, 1999 and is a continuation of said
09/376,957 Aug. 18, 1999 and claims benefit of
60/123,504 Mar. 9, 1999 and claims benefit of
60/123,207 Mar. 8, 1999 and claims benefit of
60/123,153 Mar. 6, 1999 and said
09/376,957 Aug. 18, 1999 is a continuation of

08/950,898 Oct. 15, 1997, U.S. Pat. No. 5,941,273

### FIELD OF THE INVENTION

Mass energy highest conserving (MEHC) rudimentary Fluid-Elements embody fluids' functions.

### BACKGROUND OF THE INVENTION

The Earth fluids evolve forms equal function anion bulb, laminar, globose boundaries, to contain and retain stratified fluids' magma core, solidified mantle, molecular, atomic and plasma weights constituted mass, energy, gravity, and magnetic fields enforced inside Solar/Galactic force fields.

Inventions core novelty occupies one or more of these artificial and real domains: a) president; b) forms equal function; c) functions equal forms; d) science; and, e) God's forbidden mechanisms. In fluids energy, a-domain is artificial; said b, c, d, and e domains are science domains embodied in the science Laws of Mass Energy Conservation. The USPTO fluids said functions exclusively reside boxed or rooted in homogenous fluids the a-domain criteria flat earth' technologies, cited patents described. Patents only in a-domain err exemplified by asbestos product dubbed transite, banned by b, c, and d domain function, which excludes the U.S. Pat. No. 5,941,273 drain trap highly elastic flexible tube forms equal function MEHC globose form transfers enforced configurations;

Said b, c domains without participation of d, e domains discount said USPTO cited patents fluids drain traps domain functions to an extent where simple drain trap versions are ubiquitous. Initial references discounted simple traps as bona fide b, c domains residents, further, discounted by the d, e domains, herein. The present inventions transcend said ‘flat earth’ box and force rudimental forms equal function on atomic and Universal scale, where the cited utility patents are barred due to sizes, and also function with same rudiments efficiency in said utility patents boxed in criteria.

The referenced applications MEHC flows force transport mass energy into processes globose and conduits (GC) forms universe fluids MEHC forced configuration, imposed perimeter boundaries. Listed references disclose fluids science technologies conforming function least mass perimeters.

The inventions drainage lines and drain traps' rudiments confront energy, water conservation and global warming crisis encompassing finite to infinite mass energy conserving, likewise in the d, e domains wherein the inventions said fluid elements properties rudimentary functions reside, also.

### SUMMARY OF THE INVENTION

Fluids system Elements, as Atomic Elements, least energy of distortion embody conforming least quanta mass energy quantum units paths of passage (PP) lengths least sum (PPLLS) mass energy highest conserving (MEHC) embodied path length directional and rotational tensors gravitational field one direction preference over the other two directions; fluids quanta centric properties make quintessential core (QC) in defined natural disposition atmospheric condition (ND), as in an open channel MEHC, comprise QCNDMEHC; a path directional change cedes fluids energy parts into boundaries energy of distortion. Flow energy surface dispensators (FESD) are minima energy of distortion surfaces the Drawings illustrate; globose conduit (GC) Sets and forms linear and radial fluid paths must present MEHC embodied longevity configuration imposed perimeter boundaries paths of passage with ideally generalized a path angle of passage (PAP), and a path that demands fluids' quanta configurations highest energy, the path of passage of least energy demand (PPLD); referenced applications mass and energy highest conserving (MEHC) transports mass and energy into processes globose forms mass and energy sum, quanta mass quantum, units of mass, PPLLS, system processes mass energy GC Universe fluids' MEHC imposed perimeters/boundaries; thus: Fluid composition functions conforming globose quanta least mass, highest elevation least height least length continuous compact composite fluid mass free-surfaces, a rotations composite quanta mass energy perimeter globose and conduit Universe least height surfaces most conserve energy; conforming embodiments quintessential core, natural disposition, genomes, mass energy highest conserving compact composites with completely matched complete complements embody forms; an inflow Inlet, a globose perimeters enclosure and an outlet embodied Sets or drain traps quanta quantum mass PP lengths least sum, in part an upper retention submerged a transition region, and a globose Inlet lower end, an End 2, or a globose-inverse outlet spout lower end, a First End, and respective undersurfaces; said Inlet End 2 or outlet First End force globose perimeters fluid mass steady transports along lowest surfaces short slopes height, length, for narrow breadths narrowest PPLD bands width conduit forms complement; manipulated cross-sections varied areas complete complement breadths lift, raise, and set up higher density masses in front of much larger, globose boundaries, frictionless free surfaces, conforming least mass and uniform atmospheric, restrained hydrostatic, fluids steadied pressures dynamic flows; quanta masses' transports, especially higher density fluids with raised mass centroids have said lowest surfaces right-of-ways entirely through at least three manipulated cross-sections, modulating areas; a Set complete complement breadths, constitute complete globose open channel large free-surface forms of least perimeter, height, and quanta mass rotations, PAP Line less than 180°, globose surfaces Flush Apparatus cleaned FESD forms; globose-conduit functions make much smaller fluids' quanta mass Set or forms than those of the present art; supra End 2 or First End, sidelong to anti-sidelong locations, constitute domain Sets; crossing globose and circumferential strains make up hybrid domains; said GC and globose conduits drainage lines complete complement composite breadths comprise forms, widen a small lower area, into a transition region, and into a globose upper area cross-sections; preassembled in walls, Flush Apparatus forms adeptly flush, sterilize, and or coat surfaces; supra globose conduit, Universe Sets cause natural disposition infinitesimal to infinite, quintessential, core, mass energy highest conserving (QCMEHC) conforming two globose and conforming two conduit ‘functions’ unique, classic perimeter ‘substance’ energy synchronous four perimeters, coincident boundaries, two Fluid Elements, genomes' functions complete complements, analogous to Atomic Elements;

The above Lines 17-20 defining fluids' mass energy likewise defines atoms, if the word fluid and genomes is omitted. In all three instances, forms' perimeters and mass energy are correlated, and while known for atoms that is not the case for fluids mass energy embodiments. The perimeters' correlation must embody said three entities, systems, entire mass energy, as it must not comprise no more and no less than its least mass energy, which is what the atoms include. Fluids less than least mass energy fall into forbidden mechanisms and is generally true for the atoms, also. Thus, said fluids systems and genomes function must achieve mass energy least sum; the previous page Lines 1-5 and the above comprise that sum with supra Sets MEHC conforming least quanta mass quantum, units of mass, approaching infinitesimal, constituted perimeter forms mass energy sum, embodied in the PPLLS computing to nearly infinitesimal accuracies with gravity force direction components including gravity acceleration multiple; said technology embodied atomic and fluids correlation and extends into space, dwells in the sciences said d domain, outside of utility patents president said ‘flat earth’ box technology a-domain, functioning extremely well in said box, also. The text and claim correlate forms and MEHC, forms equal function, functions equal forms, said b, c domains governed by said sciences d domain, the Laws of Mass Energy Conservation, which the submitted references, mechanics of forms configuration nearly infinitesimal details, describe. Said domain d governs a, b, and c, domain residents; a failing function resident moves into failed residents' domain, human forbidden mechanisms. The simple trap ubiquity verifies that the cited patents dwell in failing residents' domain; FIG. 1A and FIG. 1B respectively illustrate the GC Set, the simple trap forms; submitted references disclose simple traps: a) 2.5 times greater fluids mass retention; b) 5 times greater fluids mass interface surface perimeters; c) at least 2.25 times higher operating pressure; d) at least 2 times higher lift for one retained fluids mass turnover, with outlet FESDs minima back pressure; e) friction at least 11.25 times greater, b times c; f) at least 5 times more energy required, said c times d, for outlet FESD sections area the Drawings disclosed many times that of its Inlet; g) flows large friction angle directional changes, resulting in 3-90° elbows; the Drawings shown drain traps PPLD lengths graphically illustrate the energy demands physical comparisons, with simple traps PPLD more than twice as long, twice as deep and long enough to cause retention mass directional reversals due to latent responses of fluctuating fluid inflows and thus outflows, with energy losses of conflicting directional flows. Said GC Set short length, with said outlet FESD low back pressures, has least or no such energy loss. With faster turnover rates of GC Sets, the present art needs two orders of magnitude more energy; functioning forms reveal bending moment(s) in simple traps boundaries caused by shape, structurally exhibited Z property peak stresses, at FIG. 1B Points B and C; the GC forms Set stresses are essentially hoop stresses. Said two belong to different genus: GC-Sets in conduits and simple traps in digestive tract genus.

Said four GC Sets or forms MEHC are more rare than diamonds coincident perimeter boundaries four ‘functions’ embodied: 1) conforming fluids' least quanta; 2) transition region submerged; 3) high densities' particles transport; and 4) supra MEHC; said four functions likewise separate into globose and conduit ‘functions’ each embodying two, for conduits: 1) supra MEHC; 2) transition region submerged mass transport; for globose forms: 1) supra MEHC; 2) processes stratifications or non-stratifications transition region submerged; said three distinct GC function processes, with globose, conduit form MEHC common, mass unit six directions six rotations (or 7^{th} no response) twelve real responses, conduit and globose component 24 responses, make a 72 responses tensor. Nonuniform, nonhomogeneous, and nonsteady fluids MEHC processors mass energy transport in drainage lines said four functions, as conduit form equal functions, constitute mass energy Fluids Element; and, it is the Fluids Element, since it embodies maximum mass energy within perimeter of that mass, as the atoms do. As long as, fluid flows and forced by perimeter boundaries MEHC exist, no other form will utilize less energy in transport of that mass energy. Drain traps embody fluids next fundamental element and MEHC that must constitute a globose form transition region submerged surfaces with said conforming compact quanta least mass a paramount factor. Again, globose perimeter boundaries ideally contain, detain, retain, transfer and transpose compact mass within MEHC genus, exemplified by atomic elements and celestial bodies functions equal forms; said conduit and globose, GC MEHC, drain traps, constitute Fluid Elements next higher element. Supra fluids GC MEHC forms possess quintessential mass core energy with functional transports for a short conduit Inlet constituted MEHC Set genus domains, in ND, atmospheric and very low hydrostatic pressures, open channel flows, force much lower pressures than those in simple traps; FESD forms streamline PP, or configurations, or reduce conforming quanta or raise PPLD paths; sustained longevities competent Flush Apparatus assemblies the drawings illustrate and describe. Nonhomogeneous, nonuniform and nonsteady fluids uniquely configure GC Sets Universe, from FIG. 1 schematic of genus ‘parent’ visualized cross-section taken generally about PAP symmetry plane; said parent perimeter embodies potential energy to configure Inlet and outlet matches with access energy, for short and also properly configured open mouth inflow, least height Inlets, with (not shown) Inlet and outlet configurations comprising GC Universe Sets. A globose Inlet End 2 or a globose-inverse outlet First End migrations from a basin-outlet blind side to its opposite end anti-sidelong locations constitutes Sidelong, Sidelong Offset, Offset Centric, Centric, Anti Offset Centric, Anti Sidelong Offset and Anti Sidelong basic Sets and forms and upright, angled to near upright, angled, industrial, low angled, Inline, inverse, hybrid, migrations and mutations domains and genomes GC Universe MEHC perimeter Sets and forms; said parent inflow open mouth Inlet and an orifice outlet forces said parent a globose form comparative to atoms and celestial bodies. Ser. No. 09/850,927 depicts said parent as originator of said Sets, forms, and Universe, wherein each domain, GC Sets and forms, utility drain traps, PPLLS, thus MEHC, member comprises genome. Said conforming GC Sets conforming quanta least mass quantum units of mass constitute MEHC finest elements algorithm kinetic and potential and energy modes sum, PPLLS, including upright paths with gravity acceleration multiple, thus, making fluid retention low height forms perimeter; generic claim: 1) said GC embodiment; 2) conforming quanta least mass quantum, units of mass, PPLLS; 3) PPLD; and 4) PAP line angle less than 180°, references continued four generic claims fluids MEHC Sets energy that correlates with atomic structures, neutrons, protons, and electrons. MEHC Universe GC organic fluids, mouth Inlet and orifice outlet FESD embody one cell forms.

### BRIEF DESCRIPTION OF THE DRAWINGS

The invention principles the specifications describe and disclose and the drawings illustrate are not limited to the illustrated examples. Having a drawing, one could make modifications or vary figures of the same without departing from the scope of the inventions;

FIG. 1 of the drawings shows a cross-sectional view generally taken of inorganic Fluid Element genus generally about its upright plane of symmetry, shown as a globose conduit without an Inlet, and is also MEHC genome of organic globose conduit genus, similarly shown;

FIG. 1A of the drawings shows a Globose Genus drain trap schematic cross-sectional view in PAP Line upright plane of symmetry;

FIG. 1B of the drawings shows the present art simple trap cross-sectional view schematic generally about an upright plane of symmetry;

FIG. 2 of the drawings shows a Globose Sidelong embodiment invention cross-sectional view generally taken about PAP Line upright plane of symmetry;

FIG. 3 of the drawings shows FIG. 2 sectional top view taken generally about Line A-A;

FIG. 4 of the drawings shows a Globose Sidelong Circumferential embodiment cross-sectional view taken generally about PAP Line upright plane of symmetry, showing a Trough invention, an Infant-Boot End 2, a rounded spot PPLD, and a Fin, FESD forms and a Flushing Apparatus assembly;

FIG. 5 of the drawings shows a Ridge FESD cross-sectional view taken generally about Line C-C of FIG. 4;

FIG. 6 of the drawings shows a Trough FESD cross-sectional view taken generally about Line C-C of FIG. 4;

FIG. 7 of the drawings shows a Globose Centric embodiment cross-sectional view taken generally about PAP Line upright plane of symmetry showing an Infant Boot End, an Inlet centric Conical Form, a lowest annular valley PPLD, and a Bridging Wall, FESD forms, and a Flushing Apparatus assembly;

FIG. 8 of the drawings shows FIG. 7 Bridging Wall FESD cross-sectional view taken generally about Line CCC-CCC;

FIG. 9 of the drawings shows FIG. 7 Bridging Wall FESD cross-sectional view taken generally about Line C-C;

FIG. 10 of the drawings shows FIG. 7 Bridging Wall FESD cross-sectional view taken generally about Line CC-CC;

FIG. 11 of the drawings shows a Globose Centric embodiment cross-sectional view taken generally about PAP Line upright plane of symmetry showing an Infant Boot End 2, an offset Conical Form, a crescent PPLD, and a Bridging Wall, FESD forms, and a Flushing Apparatus assembly;

FIG. 12 of the drawings shows a Globose-Cylindrical hybrid Offset embodiment cross-sectional view taken generally about PAP Line upright plane of symmetry showing a Trough inside a Trough, an Inlet Flared End 2, an Inlet centric Conical-Form, and an annular valley PPLD, FESD forms, and a Flushing Apparatus assembly;

FIG. 13 of the drawings shows a sectional top view taken generally about FIG. 12, Line C-C,

FIG. 14 of the drawings shows a Globose Centric Cylindrical embodiment cross-sectional view taken generally about PAP Line upright plane of symmetry showed a rounded End 2, a conical form, an annular valley PPLD, an elliptical upright major axis outlet First End, and a DCSS, FESD forms;

FIG. 15 of the drawings shows a Globose Inverse Centric Cylindrical embodiment cross-sectional view taken generally about PAP Line upright plane of symmetry showing a rounded First End, a conical form First End centric, and an annular valley PPLD form, FESD forms;

FIG. 16 of the drawings shows a top view of a Globose Inline Centric embodiment of FIG. 17;

FIG. 17 of the drawings shows a Globose Inline Centric embodiment cross-sectional view taken generally about PAP Line upright plane of symmetry showing an Inlet inner surface of revolution flared rounded End 2, an annular valley PPL, and an outlet DCSS, FESD forms;

FIG. 18 shows a Partition FESD of a Cylindrical Inline Centric Embodiment in a cross-sectional view taken generally about an upright plane orthogonal to the FIG. 17 cross-section;

FIG. 19 of the drawings shows a Globose Angled Sidelong embodiment cross-sectional view taken generally about PAP Line upright plane of symmetry showing a curved Inlet End 2, and a counterpart basin filler member rounded PPLD, FESD forms, and a Flushing Apparatus assembly;

FIG. 20 shows a Globose Angled Sidelong embodiment cross-sectional view taken generally about PAP Line upright plane of symmetry showing a curved Inlet End 2 FESD, a rounded surface basin filler member crescent lowest PPLD, FESD forms, and a Flushing Apparatus assembly;

FIG. 21 of the drawings shows a Globose Inverse Angled Centric embodiment cross-sectional view taken generally about PAP Line upright plane of symmetry showing a First End form FESD and a basin filler member rounded lowest PPLD, FESD forms, and a Flushing Apparatus assembly;

FIG. 22 of the drawings shows Globose-Inverse Angled Sidelong embodiment cross-sectional view taken generally about PAP Line upright plane of symmetry showing a First End, a basin filler member annular valley PPLD, FESD forms, and a Flushing Apparatus assembly;

FIG. 23 of the drawings shows Globose-Inverse Angled Sidelong embodiment cross-sectional view taken generally about PAP Line upright plane of symmetry showing an anti sidelong Inlet End 1, a First End, a filler member rounded PPLD, FESD forms, and a Flushing Apparatus assembly;

FIG. 24 of the drawings shows Globose Angled Centric embodiment cross-sectional view taken generally about PAP Line upright plane of symmetry showing an anti sidelong Inlet End 1, a First End, a basin filler member annular PPLD, FESD forms, and a Flushing Apparatus assembly;

FIG. 25 of the drawings shows a Dual Globose Sidelong Hybrid Circumferential embodiment cross-sectional view taken generally about PAP Line upright plane of symmetry showing a Fin End 2, a Fin, and a Fin Partition, FESD forms, and a Flush Apparatus assembly;

FIG. 26 of the drawings shows a sectional view of FIG. 25 Partition FESD generally taken about Line C-C;

FIG. 27 of the drawings shows a cross-sectional view of a conduit form embodiment of disclosed genus conduits transporting a nonhomogeneous fluids mixture;

FIG. 28 of the drawings shows a sectional view generally taken through a circumferential basin outlet of a Circumferential Genus embodiment;

FIG. 29-31 of the drawings shows a cross-sectional view taken generally about PAP Line upright plane of symmetry of a Flushing Apparatus networks' assemblies and parts, as three versions;

FIG. 32 of the drawings shows a cross-sectional view taken generally about PAP Line upright plane of symmetry of a Globose Industrial Centric Cylindrical embodiment showing three Sub-outlets FESD forms and a Flush Apparatus assembly;

### DETAIL DESCRIPTION OF THE PREFERRED EMBODIMENTS

The invention principles the specifications describe and disclose and the drawings illustrate and are not limited to the illustrated examples. Having a drawing, one could make modifications, or vary figures of the same without departing from the scope of the inventions that make Universe;

Referring to the drawings, the inventions GC MEHC Universe said generic claims energy evolve or devolve globose or globose spherical conforming embodiments (or cylindrical approximations with height less than two diameters) retention fluids forms that rotate, mutate, transpose, transfer, as unique origin forms, Sets, hybrids, and domains, by references, especially the Ser. No. 09/850,927. an inflow Inlet, a globose perimeters enclosure and an outlet (basin outlet) embodied Set or drain traps as a globose Inlet End 2 or a globose-inverse outlet First End migrations from a basin outlet blind side to its opposite end anti-sidelong locations constitutes Sidelong, Sidelong Offset, Offset Centric, Centric, Anti Offset Centric, Anti Sidelong Offset, Anti Sidelong, comprise basic Sets or forms, and: upright, angled to near upright, angled, Industrial, low angled, Inline, inverse, hybrid, migrations, and mutations, domains and genomes GC Universe MEHC perimeter Sets and forms; correlated Fluid, Atomic Elements, GC PPLLS MEHC domains Sets comprise isotopes and ions. Retention mass horizontal plane rotated about upright axis, especially Inlet axis, and free surface stayed horizontal makes an upright Set, wherein mass free surface wobble has a near upright Set.

Said domain e human failed devices comprise one or combination of: a) insufficient Inlet energy; b) high energy demand thus high fluids mass and energy consumption; c) suction; d) clogging; e) fluids evaporation; f) high energy of distortion short longevity, based on utilization circumstance. The simple trap domain ubiquity (superiority) is despite at least said d, b and f known deficiency.

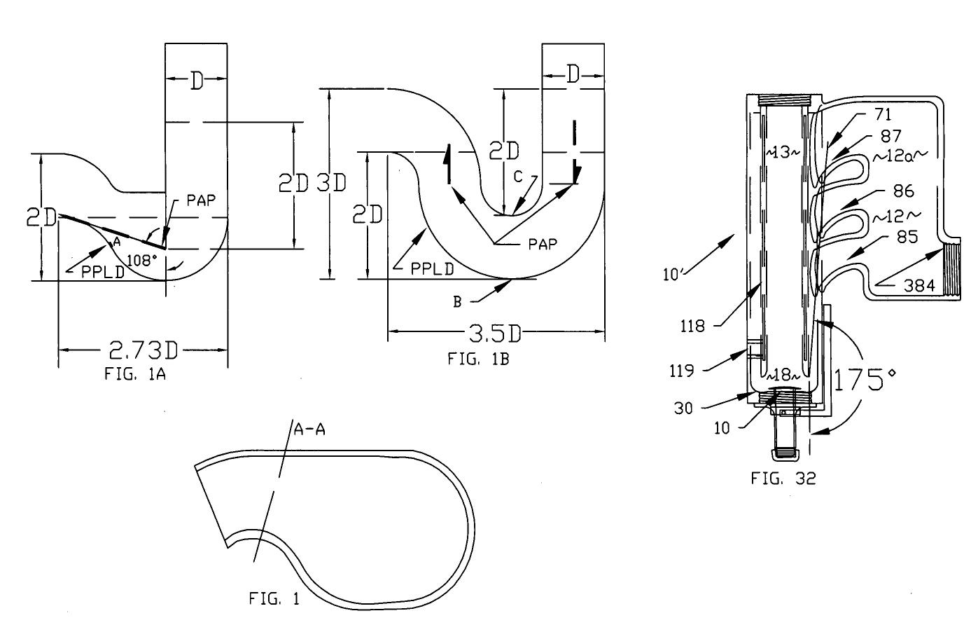

Said GC MEHC PPLLS drain traps optimal energy forms embody enormous advantages: a) even with open mouth Inlets the single cell organisms energy is highly functional; b) said outlet DCSS a First Sub-outlet greatly narrowed breadths of rounded cross-sections pass fluids largest particle and raise initially hydrostatic pressures positively submerging said crucial undersurfaces only for a Second Sub-outlet, and as needed a Third Sub-outlet, enforced least hydrostatic pressures, with an upper cross-section portion that is a passageway or a direct connection to a vent line stack that precludes suction, forcing said ND, open channel flow, into drainage line; c) said low hydrostatic pressure lowers friction and energy of distortion passed into boundaries retained greatest velocity flows; d) said least energy of distortion with GC drain trap short, even open mouth Inlet, rounded boundaries comprise hoop stresses of GC cross-sections in longest longevities; e) said drain traps utility functions to pass nonhomogeneous, nonuniform, and nonsteady fluids mass and sealed the crucial undersurfaces, conforming least fluids mass globose forms, boundaries surface area, fluid pressures, frictional losses; f) shortest shallowest said PPLD forms, paths, FIGS. 1A and 1B show; conforming embodiments PPLLS, PPLD, GC larger conduits that are magnitude greater than the Inlet cross-section area, if required up to the vent stack, preclude a suction in said GC drain traps.

Accordingly, the described inventions' embodiments comprise elements that the drawings show: a lower retention constituted GC conduit spout cross-sectional area forms constituted from PPLD path forms finite breadths increased areas up to supra globose End 2, a globose-inverse First End undersurface, horizontal, radial and infinitesimally highest increment or conduit springing points; transition region cross-sections area constitutes height, between lower conduit and upper globose forms springing points, upright plane symmetric constituting supra GC Sets and forms perimeter; a detention mass constitutes hydrostatic pressure raised retention fluid above a summit elevation; the conforming quanta mass upper retention is from fluids surface tension and adhesion height of said globose End 2, globose-inverse First End undersurface submerged, finite, highest increment; a summit constitutes an outlet ascending spout a horizontal infinitesimal width of the PPLD path, finite horizontal increment and highest infinitesimal increment end furthest from respective Inlet, and fluid tension and adhesion height higher than upper retention free surface elevation at-rest of conforming quanta fluids retention, and a finite part of a discharge cross section surface (DCSS); said PAP line constitutes an angle less than 180° in respect to the gravitational direction, aligns a Set upright plane symmetric forms through at least the Sets and forms springing points tangential (without an intersection) to counterpart said PPLD form and a tangent to said End 2 or First End; said GC basin outlet upper retention comprises largely one of truncated five: globose, spheroidal, ellipsoidal, cylinder, cylindroid, short forms shorter than the basin's larger horizontal dimension;

said critical End 2, First End undersurface is proximate ½ of fluids forms entire retention depth; GC lower retention conduits embody shallow PPLD paths form high density mass high centroid; said shrunk, shallow PPLD paths form, said transition region comprise PAP angle less than 180°; a PPLD width midpoint, said globose End 2, a globose-inverse First End undersurfaces one point tangentially constituted PAP line horizontally orients upright symmetry plane aligns the GC Sets; supra outlets, DCSS, and Sub-outlets FESD forms constitute PPLD paths form fluids conforming quant mass least slopes in a small rounded lower conduit, a transition region and a globose upper cross-sections embody amalgamated: a rounded, a curvilinear, an elliptical, and a parabolic form; said End 2, Nozzle FESD forms MEHC PPLS constitute a part of said End 2 undersurface forms;

an Inlet First End, a descending outlet spout Second End Exhaust cross-sectional area positively connects said GC Set in a drainage line, to a fluids source, said drainage line with a vented stack; connections are generally threaded, or welded or with compression couplings in the drainage line flexible portions, installed in place rigid connections, with or without gaskets, washers, bushings, a treaded nut or a double nut locked and such suitable positive connections that assemble the Set; high quality fabrications, high accuracy, plastics high pressures, metals and composites moldings and or semi-rigid materials adequately rigid or stiffened or combinations of the above make Sets;

fluids inflow through Inlet End 1, pass through GC basin outlet and outflow through the Exhaust; fluids' outflow mostly through supra GC small lower conduit, ahead of detention fluids PP paths; dual walls with space in between, gravitational direction compliant including tubing, warns of an eminent failure with immediate drips, wherein said dual walls represent the drain traps longevity; a one-way air nozzle generally, not always, substitutes for said vent-line stack precluded suction;

said Flush Apparatus assemblies and parts entirely in walls of a Set and their fluids stream access to most or all locations separately or concurrently disinfect, flush, coat repair, or protect sound or damaged surfaces; said Flush Apparatus prefabricated/pre-assembled surface locations and entire Set, a nozzle, a set, or a network of nozzles with a tie-in or tie-ins set disposed about Set dispense design fluids, air or gases, jointly or individually to separate sequences, intervals or concurrently; said Flush Apparatus tie-in assemblies check valves can act as controllers of air and design fluids inflow into a Set, to counter suction through said single or networks of nozzles and/or as sensing basin low fluid level device(s) initiated air and design fluids' inflows forced essential elevations;

said GC Sets, drainage lines, fluids least rotations, quanta mass, MEHC PPLLS, Flush Apparatus assemblies submitted references, in part the following drawings, and these FESD forms describe:

A three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s), FESD form;

A Circumferential Trough, a Ridge, a Partition, a three-dimensional Window and a Troughs-Ridge and a Troughs-Ridge-Partition and a three-dimensional Window(s), FESD forms;

A Nozzle local highly directional spout forms as a FESD form;

A globose End 2, globose-inverse First End and PPLD counterpart forms of a Set FESD forms;

A Bridging-Wall with Domed-Cavities about Inlet FESD forms;

A Fin FESD forms dividing globose-conduit cross-sections upper retention;

A Trough, a Ridge, a Partition with/without a Window(s), a Trough inside a Trough, a Troughs-Ridge, a Troughs-Ridge, a Troughs-Ridge-Partition with/without Window(s) FESD forms;

An FESD manager enhanced control of fluid free surfaces height differences;

Cavities and dome Cavities FESD forms;

A rounded End 2, First End; a flared; an infant boot; a Fin End 2, FESD forms;

A Migration as Dimension(s) 44, (44, 44′) FESD forms;

A crescent PPLD conical form FESD form;

Outlets, DCSS and GC cross-sections areas mangers and space managers FESD forms;

FIG. 1 of the drawings shows visualized GC Universe genus parent cross-sectional, side elevation view taken generally through upright symmetry plane; globose genus embodies Troughs, Ridges, Partitions, and references listed FESD forms inflows outflows controls through globose basins or cells passages, conduits and channels of nonhomogeneous, nonuniform, nonsteady fluids MEHC, PPLLS energy cells or Sets configurations of the parent through the references detailed rotations, orientations, with transfers; Section A-A almost never shows as an entirely rounded cross-section that belongs to uniform, homogeneous fluids, naturally nonexistent. FIG. 27 shows Section A-A, nonhomogeneous, nonuniform, nonsteady fluids conduit outlet constituted said GC cross-section. Said genus parent constitutes fluid energy facets of GC Universe forms nearly infinite matches of Inlets and outlets about its perimeter, starting with an open mouth Inlet inflow; said genus parent is shown with an elongated outlet form that can reduce to an orifice outlet that with supra PPLLS MEHC constituted said GC genus Second Element; the most elementary, the genus First Element constitutes MEHC, PPLLS constituted supra GC perimeter boundaries, which the FIG. 27 shows.

FIG. 1A and FIG. 1B of the drawings proximately to scale show schematic of side elevation views taken of said GC Set and a simple trap, respectively, illustrated fluids conforming quanta volume forms, PPLD and PAP, as energy parameters the Summary summarizes and submitted references detail; energy utilization of the two is shown to embody over two orders of magnitude difference.

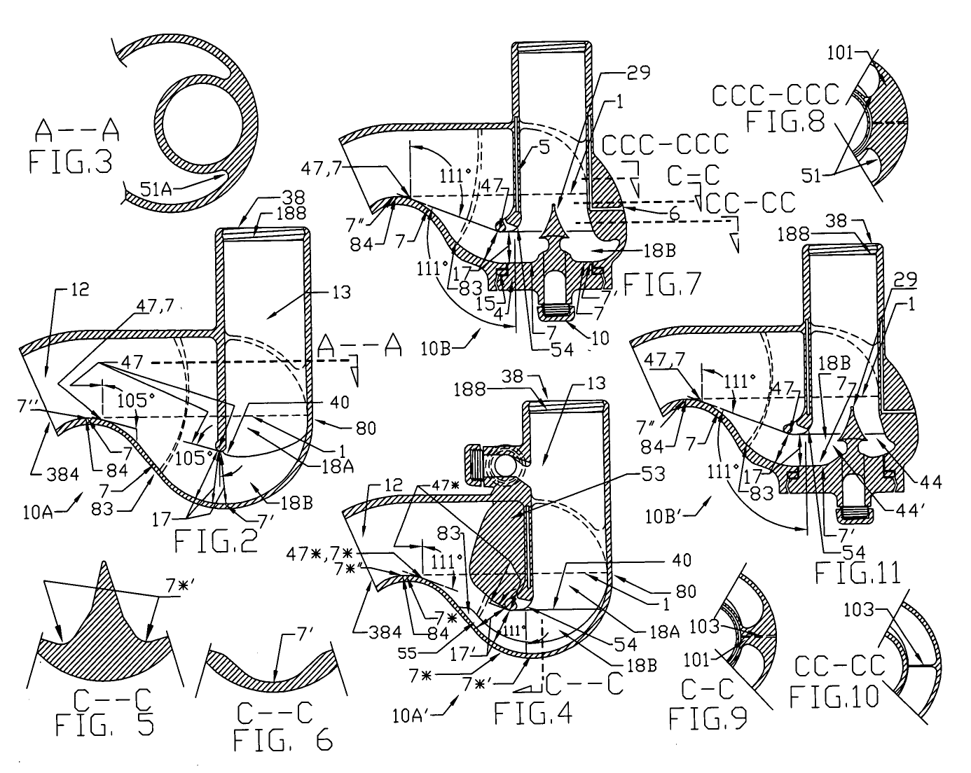

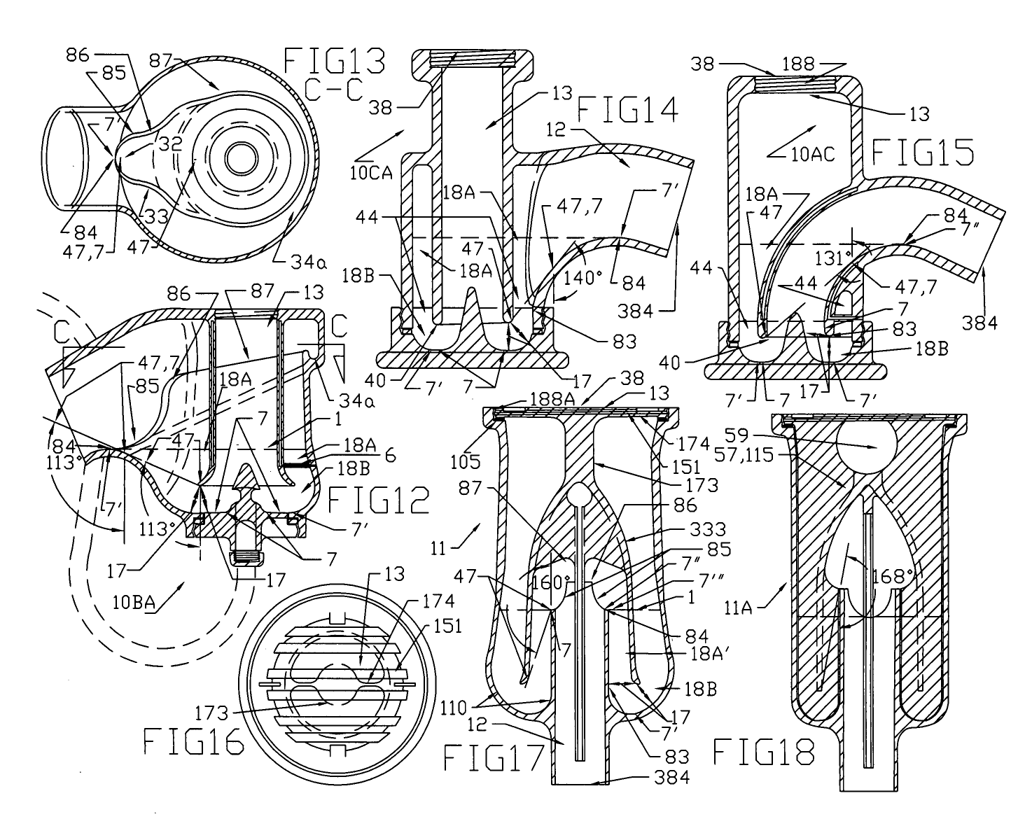

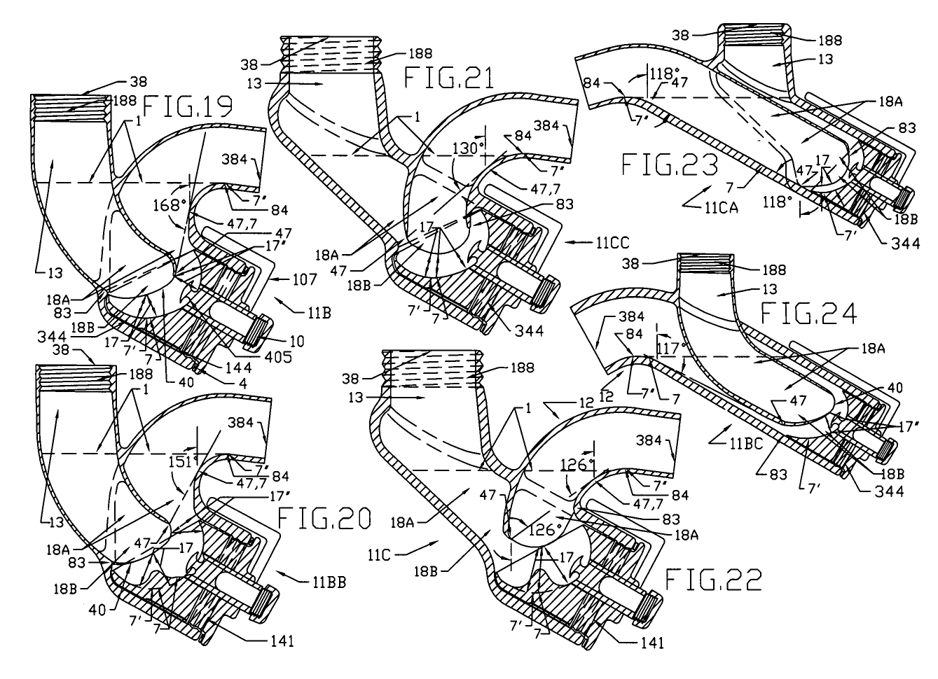

FIG. 2-3 of the drawings shows a cross-sectional side elevation view of a Globose Sidelong Set 10A drain trap taken generally about PAP upright symmetry plane. A most upright inflow Inlet 13 makes a rounded lower end annular form, an End 2 40, and an upper end, 38 an End 1; a basin outlet, GC, makes a near spherical globose basin 18 form, a narrow finite length horizontal widths merged into a band, side elevation viewed shrunk ‘S’, PPLD form 7, initiating said basin a rounded lowest spot 7′ and ending with said outlet form with a summit 84 narrowest width of band that is lowest horizontal segment of a DCSS form, which is orthogonal to said summit PPLD form; the basin outlet GC outlet 12 form consist of an ascending spout that continues said PPLD form from an outlet First End 83 surface inflection into said summit DCSS and an outlet descending spout from said DCSS into an outlet Second End, Exhaust 384, a FESD outlet form discharge cross-section; said basin with outlet amalgamates into a basin complete complement mechanics of forms GC. Said Inlet sides and globose near hemispherical basin make up narrow breach, an upper retention short height cross-sectional area Cavities FESD 51A conduit forms to merge by basin's narrowing into said outlet conduit ascending spout First End 83. Said End 2 undersurface is a short height 17 above the lowest surface spot 7′ and is said GC lower conduit lowest PPLD form spot under the Inlet, which continues basin blind side and said Inlet common surface 80 to said outlet DCSS having topside the basin PPLD form from said rounded lowest spot 7′. Fluids detention comprises fluid mass above free surface at rest continual retention 1, dashed line shown. Globose End 2 forms are entirely submerged in transition region rounded surface area forms' breadths in transition from conduit to intermediate cross-sections to globose upper retention. At most, said transition regions extend from lower conduit springing points to DCSS springing points. Said End 2 side elevation view convex undersurface sustains short 17 height separation from said basin conduit lower, lowest forms counterpart FESD surfaces. Said PPLD rounded lowest spot 7′ under said undersurface embodies said PPLD PPLLS shortest distance to said DCSS, narrowest width of band, and PPLD highest forms to summit; said PPLD highly forward slanted form has a PAP 47 105° angle PPLLS and the PPLD End 2 separation 17. Open channel mechanics of forms, outlet upper globose portion vents through a vent line stack. Said End 1 cross-section net inflow area is much smaller than either area of its respective DCSS or Second End Exhaust cross-sections. Wherefore, hydrostatic pressures from a container of said fluid mass mixture that almost always has a round drain that has a counterpart said End 1 round net area flowing full and not under a hydrostatic pressure in turn causes a rise of retained fluid free surface into its detention range. Said rounded DCSS lower area FESD form resembles and here is a First Sub-outlet oblong form widening thru its full height, then from DCSS springing points makes a globose upper cross-section crown part, FIG. 27 analogous; fluid mass inflow that causes End 1 entire net area flowing full has fluid free surface elevations proximate DCSS springing points. Said Exhaust, 384, round cross-section equivalent here to its DCSS, 84, cross-sectional area is under a potential pressure hydrostatic drop that extends from its DCSS, which for this example, is less than half full of flowing fluid. This off course allows for hydrostatic pressures rising in said fluid mass container, accounted by GC globose upper cross-sections. To minimize higher hydrostatic pressures a modified form of the DCSS with upper transition region area enlarged breadths into large globose form breadths, FIG. 12 shown circumferential channels FESD forms enlarge three times. Nonhomogeneous fluids DCSS classic forms, FIGS. 12-13, 17-18 and 27 shown forms increase breadths for a preferred DCSS least height First 85 Second 86 Third 87 Sub-outlet cross-sections; said DCSS make an outlet and a summit FESD forms that match supra GC basin outlet. Said basin blind side shows a surface inflection, 80, said rounded surface having said basin and PPLD lowest surface, 7′, a PPLD highest 50° slope, a PAP angled 47 leg of 105°, said basin, 18, respective upper, lower retention, 18A, 18B. Said End 2 shows undersurface convex form about a blind side and a front end consistent with said 17 gradual separations of said End 2 and basin surfaces; said End 1, shown threaded, connects positively to a fluids mixture source. Said outlet is shown for flexible tubing positively welded connection to a drainage line; fluid inflows through said End 1 discharges through said outlet Exhaust, 384. Said Inlet form constitutes a very short or least height.

FIG. 4 of the drawings shows a cross-sectional side elevation view of a Globose Sidelong Set 10A′ view taken generally about PAP plane of symmetry, with Section C-C, FIG. 6 shown Trough FESD or FIG. 5 shown Ridge, FESD, Circumferential Hybrid. Said FIG. 2-3 depiction of Set 10A applies except for a PAP aligned a Trough, or a Ridge, an infant-boot End 2, a Nozzle, a Fin FESD, PPLD narrowed or split forms, and a Flushing Apparatus assembly shown. Said Trough narrows a lowest surface areas cross-sections breach, PPLD width of band, and narrows and elongates said width of band lowest surface PPLD form. Said Trough 55 FESD cross-section taken about Line C-C, FIG. 6 shows globose basin lowest surface rounded PPLD form 7′ narrows breadths cross-sectional area for nearly halved thereto PP upright components; said basin outlet lowest surface with said Ridge FESD, FIG. 5 shown cross-section C-C, instead of said Trough FESD, about halves basin lowest surface breach, PPLD width of band, and its lowest surface forms by raised lowest surface cross-sections centric part. Said Ridge 55 splits and narrows cross-sections lowest surface breach, and removes centric, lowest, longest PP, PPLD to raise lowest PPLD band widths. Two PPLD forms one on each side of said Ridge form make circumferential hybrid forms PAP aligned symmetric for GC forms linear PAP aligned symmetrically said two circumferential PAP alignments that in upright elevation view show as one PAP line 71 angle of 113°. A Ridge extended beyond upper retention 1 constitutes a

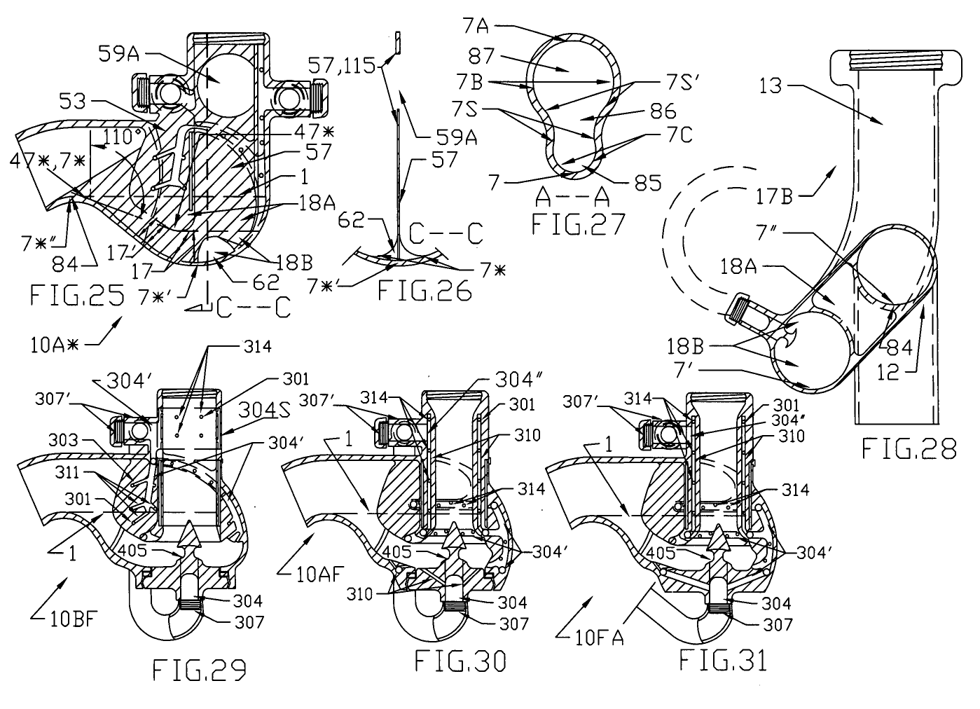

Partition. An infant boot, 54, End 2 FESD form extends an Inlet conduit cross-section through a globose basin cross-section breadth providing a least height 17 needed to sustain conduit cross-sections short height. At least one Nozzle 54 FESD form on each side of said Fin FESD through said End 2 constitutes cross-sections conduit spout highly one-directional form that provides PP shortcuts and direction alignment for adjacent PP, with inflow and outflow cones nozzle throat constituted entirely streamlined surfaces. Said Fin 53 divides upper retention into two narrow breadth conduits one directional forms. Said Inlet Cavities and infant boot End 2 FESD forms cross-section areas initiate said Fin about basin blind side complete complement forms. Shown Flush Apparatus and tie-ins assemblies FIG. 29-31 enumerate and describe; shown dual Inlet wall FIG. 7 enumerates.

FIG. 5 and FIG. 6 of the drawings show section views of a Ridge, and a Trough, respectively, taken generally about Line C-C, constituting FIG. 4 same Inlet End 2 match FIG. 4 described.

FIG. 7 shows a cross-sectional side elevation view of a Globose Centric Set 10B taken generally about PAP upright plane of symmetry showing an infant boot End 2, a PPLD annular valley, doming Cavities, a Bridging-Wall FESD, a portal cap, and Flush Apparatus assembly. An about upright Inlet with a lower end said infant boot End 2 is submerged about centric inside a globose basin constituted short PAP length, Inlet to DCSS separation. Except for said Bridging-Wall and domed Cavities and said annular PPLD, infant boot End 2 as counterpart FESD forms forgoing mechanics of forms and FIG. 1-4 explain this Set. A conical form FESD 29 initiates Inlet cross-sections reduced net area. Said Bridging-Wall and dome Cavities FESD provide PP streamlines, which make basin blind side PP longer than for a Sidelong Set; however, that is offset by Inlet's centric location shorter distance to DCSS; said Bridging-Wall takes out portion of longest PP; FIG. 8-10 sections show a Bridging-Wall 101 curved fine edge lower end 103 which thickens to bridge a basin blind side breach constituting said dome 51 Cavities FESD. Least cross-section heights 17 constitute a least height conduit about said End 2 having said annular valley lowest PPLD FESD form. Shown Flush Apparatus assembly 10 portal Plug tie-in, major nozzle 405,

FIG. 29-31 describe and enumerate; a dual wall Inlet 5, downward tube 6 with a potential drip warn that the Set longevity has expired.

FIG. 8-10 of the drawings show sectional views of Bridging-Wall Cavities 51 FESD taken about Line CC-CC, Line C-C, Line CC-CC of FIG. 7 to show narrow conduit breach about the Inlet.

FIG. 11 of the drawings shows a cross-sectional side elevation view of a Globose Centric Set 10B′ taken generally about PAP symmetry plane. Prior FIG. 7 describes mechanics of forms of this Set except for a PPLD FESD crescent form and its counterpart offset conical FESD that is also a counterpart of said End 2 FESD form; said conical form offset inside Inlet shifts a greater cross-section area closer to DCSS and shortens PP, reducing an area that leads PP toward basin blind side. Said crescent PPLD FES lowest form pitches basin lower surface toward outlet, sustains its conduit Inlet cross-section area, and shortens said basin blind side height, which reduces upright components thus eliminating longest PP with highest upright components; said Conical 29 FESD form with a PPLD crescent counterpart FESD constitutes PP lengths approaching said least sum; said Inlet and End 2, Conical, and PPLD FESD forms in adjusting breach configuration Distance 44, 44′ can merge a part or entire apex into said Bridging-Wall in a GC Centric, Sidelong hybrid.

FIG. 12 of the drawings shows a cross-sectional side elevation view of a Globose-Cylindrical hybrid Offset, Set 10BA, taken generally about PAP plane of symmetry showing a Trough 32 in a Circumferential Trough, channel, a Ridge, a Partition 34a, an oversized outlet a DCSS Tough-Ridge, a Trough-Ridge-Partition, a Ridge-Partition, and a Flared End 2, FESD forms. Said End 2 FESD extends into a fine rounded edge with a Conical rounded apex 29 counterpart FESD form that subdivides and keeps a narrow breach globose cylindrical basin form that with said FESD forms constitute narrow breach multiple passages forms. An oversized outlet spout DCSS FESD topside of basin constitutes a First 85, a Second 86, and a third Sub-outlet 87 lowest smallest, highest largest area and breach of distinctively oversized outlet areas forms that exceed basin cross-sections area and preclude suction; the outlet spout ascends as a Trough inside two circumferential Troughs FESD, which descend from said basin blind side; said basin FESD perimeter about Inlet circumferential Trough, Trough-Ridge, Trough-Ridge-Partition, and a Trough-Partition FESD constitute a three dimensional Window FESD that makes said Ridge, Ridge-Partition and Partition separation from the basin outlet upper casing; said End 2, annular PPLD and Inlet inside GC FESD forms aligned by said PAP line angle of 113° and Flush Apparatus assembly FIG. 29-31 depicted, described.

FIG. 13 of the drawings shows a top view taken generally about Line C-C of FIG. 12 of Troughs, Ridge, and Partition FESD forms, constituting a curvilinear slanted section Troughs and outlet First 32, Second 33 said Partition Window, Third said Partition Window Sub-outlet FESD forms, from said basin blind side into said descending oversized outlet spout that connects to a vented pipe, with said outlet cross-section order of magnitude greater than said End 1 cross-section area.

FIG. 14 of the drawings shows cross-sectional side elevation view a Globose Centric Cylindrical Set 10CA taken generally about PAP symmetry plane through a rounded End 2 and a counterpart Conical form and a PPLD annular FESD form. A rounded End 2 FESD, an annular valley PPLD form separation, 17, is prior Figures mechanics of forms described including an outlet ascending spout elliptical upright major axis FESD form from a First End cross-section globose area of a narrow breach conduit form; As a Centric Cylindrical counterpart of a globose Set, this cylindrical GC form migrates to a Sidelong Set with a coordinated exchange of configured breach Dimensions 44 that migrate toward said basin blind side with said Inlet and related counterpart FESD forms. Prior Figures, especially FIG. 1-7, and mechanics of forms further describe, enumerate this Set, having said PAP angle of 140°.

FIG. 15 of the drawings shows a cross-sectional side elevation view of Globose-Inverse Centric Cylindrical Set 10AC taken generally about PAP upright plane through a First End, a Conical, and an annular centric valley lowest PPLD, FESD counterpart forms. Said Inlet, here, is an extension of a basin casing and an outlet spout ascends from a First End surface inflection that is entirely submerged inside a globose retention form mechanics configured with said Dimensions 44 FESD disposed said First End. A PPLD form elevation view is a shrunk S and C form. A most preferred version of this domain is a sidelong First End that constitutes FIG. 27 outlet FESD forms, evolves into an elliptical DCSS FESD FIG. 12 shown by, and herein shown PPLD form, with a dual wall outlet, and said PAP Line angle of 131°; with a pitched basin toward outlet FIG. 11 shown preferred PPLD transfers this Set to a globose-inverse, globose-sidelong hybrid Set.

FIG. 16 of the drawings shows a top view of a Globose Cylindrical Inline Centric Set, which FIG. 17-18 and listed references further describe.

FIG. 17 of the drawings shows a cross-section side elevation view of a Globose Inline Centric, Set 11, taken generally about PAP upright plane symmetry. An Inlet 13 has an inner 333 hollow conical largely a surface of revolution Partition form, that encloses conduit spouts upright outlet form, and a lower end a flared rounded End 2 FESD forms; the GC Basin outlet forms constitute largely a globose hemispherical basin two shortest PAP 160° Line angled 71 legs, one on each diametrically opposite side of said Inlet, outlet. Said Inlet rounded cross-sections areas outer Inlet form from said basin-outlet extends with a slight narrowing into an End 1 positively locked, supported about said End 1 by a blind flange part of waste water container; a basin lower surface rounded valley sides 110 and lowest surface narrow width of band annular PPLD FESD forms under said End 2 around said outlet 12 ascending/descending spout, respectively. Said basin-outlet spout FESD forms constitute progressively a narrow, a widened and a narrowed breach from Said End 2 annular cross-sections into an Inlet/outlet ascending spout, which constitutes an FESD manger forms inventions that varies velocity of fluid mass as it negotiates a sharp turn. Said outlet upright spout outside surface and a hollow conical form inner surface constitute ascending outlet spout decreasing breach cross-sections and area outlet FESD form from a First End 83 into a First 85 a Second 86 and a Third Sub-outlet 87 DCSS FESD forms. Said DCSS FESD three-dimensional surface dwarfs First Sub-outlets areas with two summits 84 and PPLD 7′ forms said PAP Line aligned symmetric. Said outlet as a rounded form Partition FESD manager splits ascending spout breach and rising spouts cross-sectional areas, narrows otherwise wide breadths through a significantly large PAP angle, and as an FESD removes a detrimental space under Inlet for PP lengths lower least sum; said descending outlet spout comprises a three-dimensional and Partition FESD manager of retention forms breach and cross-sections separate fluid inflows into two, DCSS FESD Sub-outlet forms; a perforated upright 171 conduit disposed centric inside said outlet side plates welded to said hollow conical form with a space gap under apex constitutes a three-dimensional Partition FESD conduit round form with perforations as two-dimensional Window FESD forms that control suction. Said outlet and two DCSS Sub-outlets constitute counterparts FESD surfaces to Inlet cross-sections and said End 2 FESD undersurface. Said hollow conical form Partition FESD ends into a rounded 173 post; said Inlet outlet FESD counterparts constitute basin-outlet conduit spout side surfaces lower basin surface and PPLD FESD counterpart forms; said Inlet conical form with an outlet spout inside disposed across retention form locations constitutes said Set mutations. Said outlet disposed across Inlet retention locations constitutes mutation in respect to an Inlet. Two sets of mutations exist, one inside basin the other inside Inlet that must account for PP lengths sum; an angled Inlet and an outlet, an angled Inlet with a counter rotated outlet, and an angled Inlet and an angled outlet can constitute respective PP lengths least sum forms. Thus, globose Inline Set forms make-up numerous domains said references detailed. Said post is fixed in place by a flange 174 brace, a brass gasket, 105, a strainer, 151, and keys, 107, 107a, treaded about an End 1.

FIG. 18 of the drawings shows a cross-section side elevation view generally rotated 90° to the cross-section of FIG. 17 comprising a two dimensional Partition 57, 115 FESD manager form that splits Set forms into about equal halves; a two-dimensional rounded upper Partition Window 59 FESD form doubles cross-sections breach about, through a partitioned Inlet upper end. In operation, fluid rising in one of retention forms to a Window height, inflows into retention with a lower free surface. A Partition FESD manager is a freely supported form about its sides with or without a locking flange. A Partition FESD Window edge ranges from sharp to fine rounded and conical post forms feather into said edge.

FIG. 19-20 of the drawings show a cross-sectional side elevation views taken generally about PAP symmetry plane of Globose Angled Sidelong Sets 11b. Said highly angled forms angled from a lower basin to a basin-outlet, Inlet intersection, rotate Inlet upper end to nearly upright upper end, an End 1, respectively. A globose Set End 2, a basin-outlet lowest surface, and its outlet forms counter rotate to complete complement of FESD forms. Sets nearly upright Inlet upper end constitutes nearly an entire End 1 cross-section area topside retention free surface at rest. A globose-conduit spout and said angled conduit Inlet that significantly diverge from a globose lower basin common location constitute a First End, 83, about said End 2 and make for one length upper retention form of said Inlet and outlet spout retained fluid forms. In respect to said Inlet rotation, said basin outlet counter rotate including lowest surface, PPLD forms. An outlet elliptical upright major axis spout FESD form extends through a DCSS 84 form into an outlet round Exhaust as prior figures explain for outlet and DCSS FESD perimeter forms. An End 2 convex profile and counterpart globose basin PPLD FESD by said rotations to nearly horizontal forms constitutes a nearest to the gravitation direction orthogonal said Inlet End 2 in basin-outlet forms. Shown PAP Line angles with counter rotated First End, basin-outlet outlet spouts lowest surfaces are only about 168°. Upper retention two conduit forms retain fluid mass at rest in short height conduits separate retained fluid at rest compact mass that embodies basin fluids. FIG. 19 shown End 2 is more curved compared to FIG. 20 End 2 and having counterpart basin lowest surface spot PPLD rounded forms. FIG. 20 End 2 is less curved and has a rounded basin rounded annular valley lowest surface 7′ lowest spot, a rounded crescent form valley about a Conical rounded apex 29 shown PPLD forms with said two drain traps having nearly identical GC basin outlet forms; said lowest PPLD forms are blind side located and make PPLD, End 2 FESD counterpart forms with least height 17 separations from respective End 2. Said angled Sets include respective Filler Member 344, 141 as parts of a Plug Member, 104, handle, 107, with a key, 144, a gasket, 105, and a Flush Apparatus major assembly major nozzle 405 shown tie-in capped but connects to a design fluids source.

FIG. 21-22 of the drawings show a cross-sectional view side elevation of a Globose-inverse respective Angled Centric and Sidelong 11C Sets taken generally about PAP symmetry plane of highly angled Sets previously described respective FIG. 19-20 Sets highly similar basin lowest surface forms. Said GC spouts and angled conduit Inlet significantly diverge from a globose lower basin common location to constitute an End 2 about a First End 83. Shown PAP angles of rotated First End, basin-outlet outlet spouts lowest surfaces are only about 130 degrees, and an upper retention two conduit forms constitute fluid mass as previously stated short height two conduits separates retention forms, which retains fluid at rest compact mass for mechanics of forms previously described and not limited to angled Sets.

FIG. 23-24 of the drawings show a cross-sectional side elevation view of a Globose-inverse Low PAP Angle Sidelong and a Globose Low PAP Angle Centric Set 11ca, 11BC, respectively taken generally about a PAP symmetry plane of highly angled forms that angle from a lower basin. From a basin-outlet intersection an Inlet upper end rotates to near upright for a horizontally disposed End 1. Respective globose End 2 convex form, a globose-inverse First End respective basin-outlet lowest surfaces partially horizontal counterpart forms constitutes respective FESD complete complement of forms. Respective Inlet upper End 1 about constitutes most of entire End 1 cross-section area entirely topside retention free surface. Respective cylindrical GC and near upright Inlet forms significantly diverge from a globose lower basin location said globose End 2 about a First End 83, globose-inverse First End about End 2, respectively. Said Inlet and GC spout permanent retention fluid is one short height cylindrical globose form. Said basin, Inlet, and outlet rotated lowest surfaces through respective End 2 for respective least 17 height and breadth, breach outlet forms constitutes said PP lengths least sum, least upright components said PPLLS. Said PAP angle entirely through its outlet spout form is 117-118°, only. A rounded basin rounded lowest surface 7′ or a substitute plug member crescent form constitutes a PPLD FESD lowest spot, which starts said PPLD band width, started from basin respective sidelong locations constituted said 83 First End, End 2 FESD forms short height separation. An Inlet upright end shown anti-sidelong offset is planned for stated known disposed Inlet migrations in respect to an outlet length and vice versa with a range that exists for the Sets in these domains.

FIG. 25 of the drawing shows a cross-sectional side elevation of view Dual Globose Sidelong Hybrid Circumferential invention Set 10A*, taken generally about PAP(s) upright plane of symmetry showing a Fin, a Fin-End 2, a Partition 57,115 a Fin-Partition FESD forms and a Flush Apparatus assembly. Mechanics of figures and forms, FIG. 1-4, 14, and, especially FIG. 4 side elevation view, generally illustrate Fin, Ridge, Inlet, and basin-outlet similar FESD forms. A Partition-Fin 57 FESD bisects symmetrically said Inlet and basin-outlet retentions and Set forms except for tie-ins. Two PPLD widths of band and PAPs, one on each side of said Partition-Fin FESD constitute separate narrow widths' bands from two rounded lowest PPLD forms elongated toward outlet merged into a common rounded PPLD form by a Partition Lower Window 62. Said Fin-End 2 FESD sustains conduit short height 17 from a lowest PPLD form and 17′ through a highest PPLD grade pitch of about 50 degrees, at said First End 83 surface inflection; one PAP 47* upright surface on each side of a Partition, Fin aligns respective forms and PPLD FESD 7* widths of band. PAPs constitute a plane of symmetry shown angle of 110°. A Partition Upper Window rounded form is side truncated by an Upright Ridge 317 and spans an uppermost part of said Inlet Partition. Shown Flush Apparatus assemblies' four tie-ins are identical in function and are FIG. 29-31 described and enumerated.

FIG. 26 of the drawings shows a sectional view of FIG. 25 of Partition FESD generally taken about Line C-C through Lower 62 and Upper 59A Windows FESD. PPLD forms 7* lowest form 7*' shows a basin rounded lowest surface raised into said Partition as depicted and very much FIG. 4-5 Ridge FESD form similar.

FIG. 27 of the drawings shows a cross-sectional view of a GC, globose conduit form constituted a lowest smallest of three cross-section areas constituted rounded conduit 85 with an upper portion merged into a larger rounded cross-sectional area, supra transition 86, also, with an upper portion merged into a largest of the three a globose cross-sectional 87 area, and the three constitute a GC FESD nonhomogeneous, nonuniform nonsteady fluids genus First Element conduit cross-section form MEHC, PPLLS constituted supra GC perimeter boundaries, with the FIG. 1 disclosed genus GC Second Element; the submitted references further disclose aspects of the first Fluid Element.

FIG. 28 of the drawings shows a circumferential strain generic Set's form with a sectional view through a basin form. A side elevation view linear PAP is forms upright surface symmetry.

FIGS. 29-31 show a cross-sectional taken generally about PAP upright symmetry plane of Set 10BF, 10AF, 10FA illustrating Flush Apparatus parts to flush, disinfect, surface protect or repair a deterioration and wear. FIGS. 4, 7, 11, 12, 19-25, and 28-31 show Flush Apparatus assemblies, many of them a tie-in to a major nozzle, which constitute a capping or a plug member for a basin lowest surface access through a portal. Flush Apparatus are entirely inside conduit walls, but for tie-ins, and are capable of flushing any location, such as basin retention, Inlet surfaces and or basin-outlet lowest surface PPLD width of band entire lengths. Flush Apparatus assemblies are pre-molded pre-assembled fluid, or gas, and or air supplied under controlled pressure to tie-in or tie-ins having an easy access. Sub-nozzles, 301, sub-passageways, 303, major nozzles, 405, major passageways 304, 304′, 304″, 304S passageways 310 and respective branches set 307′ of tie-ins 307, a set of sub-passageways branches, 311, a set of sub nozzles 314 are selectively pre-assembled to deliver a designed specific pressure to a nozzle. Apparatus numerous parts assemblies are simplified by molded fabrication of parts inside conduit walls. A tie-in or a set of tie-ins is only outstanding part from a conduit wall and receives its pre-selected designed fluid(s) under pre-selected pressures to designated nozzles. A specific shape passageway such as upright Ridges FESD, FIG. 25, 29-31 depicts, a double wall inner space, 304S, passageway FIG. 29-31 depicts. A major nozzle 405 for a respective major passageway is spray type to flush entire basin lower, lowest surface and into an outlet and lower Inlet. FIG. 29 upper inlet illustrates a double wall passageway, 304S, a sub-nozzles set, 314, and nozzles 301, and a lower Inlet and a basin passageway set, 304′, and sub-nozzles, 301. Shown Fin FESD form includes a sub-passageway, 303, set, 311, and sub-nozzles. FIG. 30 shows two Ridges FESD extended for an entire Inlet height, wherein said upright PAP plane aligns a passageway 310, a set of sub-nozzles, 314, and major passageways two rings inside lower Inlet walls with a set of sub-nozzles, 314; the Flush Apparatus assemblies consist of a Plug 4 or a Cap 4, a gasket for a major nozzle 405 and parts as enumerated above.

FIG. 32 of the drawings shows a cross-sectional side elevation view of a Globose Cylindrical Industrial Centric hybrid Set 10′, generally taken about a PAP upright symmetry plane, intended for industrial drain lines that may discharge at high hydrostatic pressures. Said Set forms contain significantly larger retention, detention volume belongs within said GC domains of forms. Inline upright forms easily rotate into angled hybrid Industrial forms with outlet three Sub-outlets, an S PPLD, FESD form and a First Sub-outlet 85 summit 84. With a holding Chamber 12a, retention free surface elevation above summit makes fluid free surface one length form upper retention. A Second Sub-outlet spout ascends curving into a DCSS FESD form rounded area 86, and a Third Sub-outlet largest of three ascends to about an Inlet End 1 elevation as a DCSS FESD form area 87; said Chamber highest location one-way nozzle air inflow (not shown) or a direct connection to a vent stack constitutes safety backup protection. A Plug 10 Flush Apparatus assembly is as shown in prior figures. Shown Chamber can extend lower than a basin lowest surface. Holding Chamber fluid mass free surface during high discharges that about matches one in basin outlet moderates fluctuations caused by hydrostatic pressure high fluctuation of Inlet 13 inflows; said Inlet connected to through a universal water tight joint can allow PAP 71 Line angle alignment based on fluid mass and energy composition, quality, and quantity and thus highest mass energy conservation; clockwise rotation reduces shown PAP angle of 175°. In operation higher specific gravity solids are passed through said First Sub-outlet with large quantities of transport medium detained to pass through Second and Third Sub-outlet, and in process transport medium potential energy is again utilized to keep high hydrostatic pressures that prioritizes heavier fluids passage;

Said Industrial set constitutes FIG. 2-3 Set upright axes magnified several times that also reduces said PAP Line angle. And, conversely said Industrial Set upright axes shrunk constitutes the Set of FIG. 2-3 with the FIG. 27 outlet FESD form, and also FIG. 1, 2-3 shown GC forms, and also is very brief insight into reference Ser. No. 09/850,927 nonhomogeneous, nonuniform, nonsteady fluids conforming embodiments conforming quanta MEHC least mass PPLLS GC Sets origin from said parent or the Second Element of said fluids, FIG. 1 illustrated.

What is claimed is in this claim

1

:

1. Fluid composition functions conforming globose quanta least mass, highest elevation least height least length continuous compact composite fluid mass free-surfaces, a rotations composite quanta mass energy perimeter globose and conduit Universe least height surfaces most conserve energy; conforming embodiments quintessential core, natural disposition, genomes, mass energy highest conserving compact composites with completely matched complete complements embody forms; an inflow Inlet, a globose perimeters enclosure and an outlet embodied Sets or drain traps quanta quantum mass PP lengths least sum, in part an upper retention submerged a transition region, and a globose Inlet lower end, an End 2, or a globose-inverse outlet spout lower end, a First End, and respective undersurfaces; said Inlet End 2 or outlet First End force globose perimeters fluid mass steady transports along lowest surfaces short slopes height, length, for narrow breadths narrowest PPLD bands width conduit forms complement; manipulated cross-sections varied areas complete complement breadths lift, raise, and set up higher density masses in front of much larger, globose boundaries, frictionless free surfaces, conforming least mass and uniform atmospheric, restrained hydrostatic, fluids steadied pressures dynamic flows; quanta masses' transports, especially higher density fluids with raised mass centroids have said lowest surfaces right-of-ways entirely through at least three manipulated cross-sections, modulating areas; a Set complete complement breadths, constitute complete globose open channel large free-surface forms of least perimeter, height, and quanta mass rotations, PAP Line less than 180°, globose surfaces Flush Apparatus cleaned FESD forms; globose-conduit functions make much smaller fluids' quanta mass Set or forms than those of the present art; supra End 2 or First End, sidelong to anti-sidelong locations, constitute domain Sets; crossing globose and circumferential strains make up hybrid domains; said GC and globose conduits drainage lines complete complement composite breadths comprise forms, widen a small lower area, into a transition region, and into a globose upper area cross-sections; preassembled in walls, Flush Apparatus forms adeptly flush, sterilize, and or coat surfaces; supra globose conduit, Universe Sets cause natural disposition infinitesimal to infinite, quintessential, core, mass energy highest conserving (QCMEHC) conforming two globose and conforming two conduit ‘functions’ unique, classic perimeter ‘substance’ energy synchronous four perimeters, coincident boundaries, two Fluid Elements, genomes' functions complete complements, analogous to Atomic Elements;
